(19) United States
(12) Patent Application Publication
(10) Pub. No.: US 2004/0059797 A1
(43) Pub. Date: Mar. 25, 2004

(54) System and method for enabling a web user to control network services

(75) Inventors: Erez Velan, Nahariva (IL); Ram Machness, Tel-Aviv (IL); Raviv Zeev, Kfar-Sava (IL); Yair Arian, Pardesia (IL); Erez Kedem, Bat-Yam (IL)

Correspondence Address: DR. MARK FRIEDMAN LTD., C/O BILL POLKINGHORN, DISCOVERY DISPATCH, 9003 FLORIN WAY, UPPER MARLBORO, MD, 20772, US

(73) Assignee: G-Connect Ltd.

(21) Appl. No.: 10/247,479

(22) Filed: Sep. 20, 2002

(51) Int. Cl. G06F 15/16

(52) U.S. Cl. 709/219

(57) ABSTRACT

A system and method for indirectly controlling network devices, implemented using standard protocols, without a server at the network device. The network device monitors the traffic between a WEB server and a WEB browser. The control is implemented by embedding commands and responses in standard HTTP redirect requests sent by the WEB server to the WEB browser. The network device monitors the requests, and detects the commands according to the port number they are sent from. If the commands are HTTP redirect requests and comply with a specific command format, the network device implements the commands. Additional services may be provided, wherein a RADIUS server, security module etc. are connected to the network device.

### FIELD AND BACKGROUND OF THE INVENTION

1. Field of the Invention

The present invention relates generally to the field of communications in data networks, and in particular to a method and an apparatus for enabling end-users to control network services from a service provider.

2. Description of the Related Art

Internet Service Providers, hereinafter referred to as “ISPs”, are organizations that typically provide access to the Internet and optionally additional Internet services. Initially, ISPs enabled their customers to connect to the Internet, using standard connectivity packages such as navigation time and mailboxes. More recently, especially since the popularization of connectivity services such as ISDN, ADSL, WLAN, and Cable Internet, there are many more options that are available to the ISP customer. The customer, more and more, is able to determine the type and speed of access, as well as the particular services required. Today's leading ISPs, in addition to providing generic Internet access services, therefore require Service Creation Systems that allow rapid creation and delivery of customized Internet services to the mass market.

In this light, an ISP is typically required to be able to provide services to subscribers, depending on the subscriber's service requests. For example, an ISP may require provision of different bandwidths of data flow to different subscribers, according to each individual subscriber's requests. Typically, users wanting to change their connectivity packages are expected to contact their ISP and request (telephonically, by email or by Web page) the required services. The request is then dealt with by the service personnel, and implemented manually. It is anticipated that these network services will undergo significant changes in automation and customization, wherein customers ordering services take a more active part in the ordering process. This trend has already begun to be shaped by various technologies that enable end-users to make their service requests, via Web pages, such that their requests are implemented automatically.

A related technology can be seen with reference to U.S. Pat. No. 6,236,332 (Conkright et al.), which is fully incorporated herein by reference, as if fully set forth herein. This patent describes a two-way wireless communications system for permitting the control, monitoring and collection of data from electrical apparatus by a host computer. Included in this system is subscriber software for establishing a communication protocol with each unit. The subscriber software permits customers to have desktop control of their electrical apparatus associated with a remote unit, which includes a power supply and modem. Each unit is capable of real-time monitoring and control of the electrical apparatus associated with the unit. This patent relies on the application of the specialized subscriber software in order to generate the communications between the host and the electrical apparatus.

Furthermore, U.S. Pat. No. 6,237,031, to Knauerhase et al., which is fully incorporated herein by reference, as if fully set forth herein, describes systems, methods and devices for dynamically controlling a network device, such as a proxy server, such that the proxy server is capable of acting upon information passed to it, whether it be a command embedded in a request originated by a client computer or content provided by a server computer. According to one particular embodiment, a dynamically controllable network device comprises a control module having a parser and a service provider. The parser includes instructions for selectively invoking the service provider in response to a command parsed from an external input received by the network device.

The Intel invention, as mentioned, is for a Proxy HTTP server, and therefore requires configuration of a client (WEB browser) to work with the proxy (i.e. it is necessary to configure the client with the IP address and port of the proxy server). Another alternative implementation of the Intel invention is to have a WEB page on the network device. In this case, the network device is an HTTP server, and therefore a special ((HTTP)) protocol is required for implementation), and the service cannot be provided from a central location. Furthermore, the Intel invention requires of the client to know in advance the URL of the network device providing the service. The Intel invention emphasizes thereby enables control, in the sense of management, of a network device (server).

As can be seen in FIG. 1, such technologies typically require Web servers, which provide the Web pages (content) wherein the user can navigate and enter preferred commands. An example of such a server is a Service Selection WEB server (SSS) 16, which is a Web server that provides network service provision functionality. Such service provision technologies typically require the provision of network devices that function as service enforcement points that implement the requested services and controls, by controlling the network traffic between end-users and their service provider's. An example of such a service enforcer is a Service Creation System (SCS) 12, which is a special network device for implementing user services on a per user basis.

In typical network architecture that enables end users to control network services, it is generally necessary to configure a Policy Server 17 and a RADIUS server 18. The Policy server 17 communicates with the Network device 12 using a specific protocol (standard or proprietary), commanding the network device 12 to provide a certain service by using a service name. The definition of this service name is either stored in the network device 12, or optionally is in the RADIUS server 18. The RADIUS server 18, which is a server that utilizes a standard protocol known as the Radius protocol, typically provides services such as authentication, authorization and accounting services to the network device.

Typically, such a SSS 16, which is accessed by a standard WEB browser operating on the end-user computing device 10, controls and manages a Service Creation System (SCS) 12 based on the selected services. The implementation of these services typically requires all user requests to be intercepted, analyzed and recomposed in new requests, by the Web server 16, in conjunction with the Policy server 17 and RADIUS server 18. The Policy server 17 then sends these new requests to the network device 12, using a specific protocol, where they are identified and implemented. An example for such a protocol is Common Open Policy Service (COPS), which is a standard for exchanging policy information in a network. Such a process is often relatively costly to setup and maintain, requiring an additional policy server, and either software or protocols for this server to communicate with the network device. The addition of the policy server 17 requires instituting changes in the network, such as instructing the Web server to send all client queries to the policy server before the queries can be returned to the client. Such changes impact on the operation of the ISP network, and typically slow down server response times and complicate the ISP network configuration. Another disadvantage is that two different databases are used for implementing the service, namely a database of the Policy server and a database of the RADIUS server, between which synchronization problems may arise.

There is thus a widely recognized need for, and it would be highly advantageous to have, a system that is easy to integrate into the ISP network, and can enable service creation without the need for such special managing devices and protocols, thereby providing more cost effective and user-friendly service provision.

### SUMMARY OF THE INVENTION

The present invention relates to a system and methods for enabling Internet users to determine network services provision from ISPs, thereby enabling an easy to implement technology for providing dynamic selection and delivery of customized services to Internet users. The present invention simplifies the model of service creation by not requiring special managing devices and protocols for these services. Therefore, the complexity of introducing an Internet Protocol (TCP/IP) based service creation platform is drastically reduced. No accompanying devices or protocols to the Service Creation System (SCS) are required, and a standard WEB server and WEB browser software are all that are needed for the Service Creation platform to be operated. All the necessary service commands and additional relevant information (such as results) are conveyed from the server to the end-user by being embedded within standard traffic TCP/HTTP packets communicated between the relevant devices, thereby having no noticeable impact on data flow through the network.

The services selected can be service policies, profiles (such as a gold package or a bronze package), or single services. An example of a service is a request for a desired bandwidth. The Internet user, accordingly, can automatically increase or decrease the allocated bandwidth, and the Service Creation System implements the new bandwidth limits and the implied billing for the service. Another example for a service is a security feature such as anti-spoofing. The user selects the feature using the Service Selection Server and the anti-spoofing is implemented in the Service Creation System for the specific user. The Service Creation System is also responsible for providing the accounting information necessary for billing the user for this service.

According to a preferred embodiment of the present invention, as can be seen in FIG. 2, the Internet user 20, who is connected to the World Wide Web (WWW) 24, selects the network services required using a Web page (HTML and/or JAVA based content etc.) delivered to typical Internet browser software by a WEB server 26. The WEB server 26 identifies such a request/command and embeds the required commands in the HTTP URL query field of a standard HTTP (redirect) request to be sent to the client 20. The HTTP request with the embedded command, which may include the original data packet (that contained the user's command), is subsequently sent to the client, but is intercepted by the network device 22. The network device 22 identifies the presence of such commands by verifying the port number of a request, the HTTP redirect feature of the request, and the particular format of the HTTP URL query field. Upon verification of such service selections/commands, the requested services are implemented on a per user basis.

The network device 22 optionally communicates with a Remote Authentication Dial-In User Service, hereinafter referred to as “RADIUS” server 28, in order to provide authentication, authorization and accounting services to the network device 22. The network device 22 optionally adds information in response to the commands received, by overwriting pre-prescribed fields in the HTTP redirect request's URL format. The information overwrites fields such as RESULTS, reflecting the status of the command (such as “failed”, “succeeded” etc.), or other information fields such as CLI and the user calling phone number. The information fields maintain the same quantity of bytes in the packet, so that the request communicated thereby using TCP (Transmission Control Protocol) will not be understood as having been incorrectly communicated. In this way, the Service Creation System (SCS) 22 provides dynamically self provisioned network services to Internet users. The incorporation of the RADIUS server within the present invention enables a service supplier to charge for the various services offered on a customized basis.

### BRIEF DESCRIPTION OF THE DRAWINGS

The principles and operation of a system and a method according to the present invention may be better understood with reference to the drawings, and the following description, it being understood that these drawings are given for illustrative purposes only and are not meant to be limiting, wherein:

FIG. 1 is an illustration of the basic network architecture, according to existing network providing technologies.

FIG. 2 is an illustration of the basic network architecture, according to the present invention.

FIG. 3 is an illustration of the network device functionality, according to the present invention.

FIG. 4 is an illustration of the operation flow according to the present invention.

### DESCRIPTION OF THE PREFERRED EMBODIMENT

The present invention relates to a system and method of enabling end-users to indirectly control the provision of network services by an ISP. The presence of the system is transparent to the user and to the Service Provider as it is integrated in the existing Service Provider network, and does not require additional device and/or protocol development. The end-user interacts with the system's standard WEB server/s using a standard WEB browser and automatically receives the services he or she has asked for. This is enabled by embedding the necessary service commands and results in standard HTTP data packets from the server to the end-user. These packets are sent from the Web server to the client, and are not required to travel via additional devices, such as a policy server, thereby having no noticeable impact on data flow through the network.

The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

The principles and operation of a system and a method according to the present invention may be better understood with reference to the drawings and the accompanying description, it being understood that these drawings are given for illustrative purposes only and are not meant to be limiting, wherein:

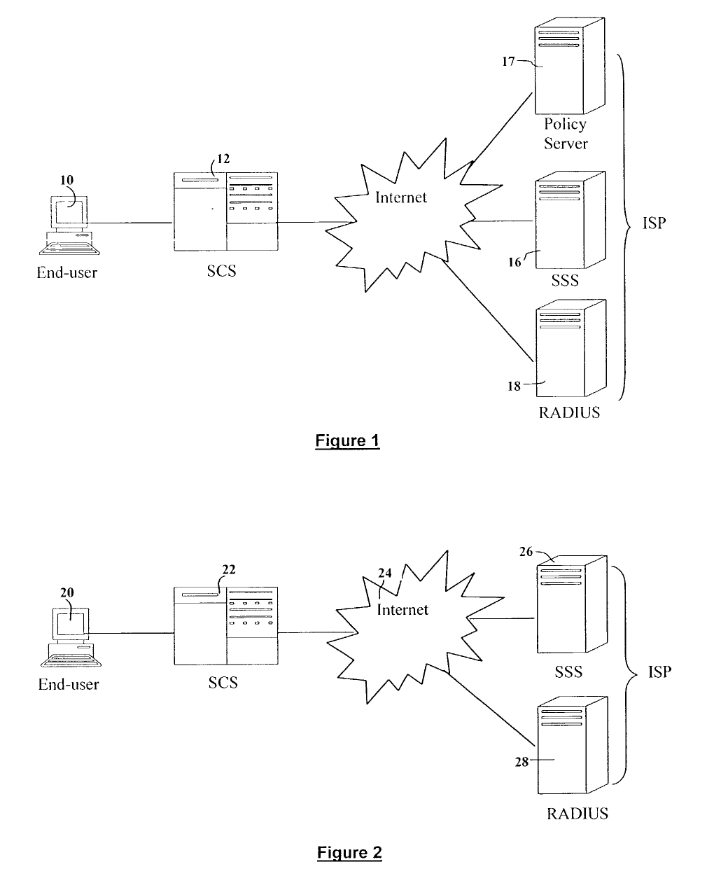

Specifically, the present invention can be used to enable an Internet user to interact with a Service Selection Server (SSS) for the purpose of selecting network services, and automatically implementing the elected services from the user's ISP. As can be seen in FIG. 2, the network components, according to the present invention, are as follows:

i. An end user device 20, by means of which the end user connects to the Internet, using the ISP network, and interacts with online (Internet) content.

ii. A Web server, or SSS 26, for providing a user interface (typically using content in an HTML and/or JAVA based Web page) from the ISP 18 to the end user. The SSS 26 also presents network services to users, processes user requests, and enables reading and writing of users' service requests in standard WEB pages, according to a specific format. The format is based on HTTP redirection using a URL query format.

iii. A network device, or Service Creation System (SCS) 22, for enabling customized control of network services for network end-users, on a per-user basis. In particular, these services are executed by enabling reading and writing of service commands in standard HTTP redirect requests, according to a URL query format.

iv. Optionally, a RADIUS server 28 is operationally connected to the SCS 22, for providing authentication, authorization and accounting (hereinafter referred to as “AAA”) services to the network device. The RADIUS server provides these services for the user sessions as well as for the services requested by the user. These services may also include CHAP. Secure ID, or any other authentication method employed per user session. The AAA functionality may also be provided on a per service basis.

The Web server (SSS) 26 is a standard WEB server that additionally provides network services to users, via standard WEB pages. No special software is required for the provision of services to the end-user browser software, and no special configuration is required for the Web browser to work with a proxy. The SSS is not restricted in location over the Internet. The SSS, according to the present invention, is equipped with the means to control the network device, by embedding the user commands in a specific format in standard HTTP URL query fields. These means are provided by a method explained to the WEB server programmer, of the HTTP redirect query field format. There are two typical possibilities for fields in the special URL format: queries (for the network device or for the RADIUS server via the network device), and service activation requests.

The network device (SCS) 20 implements the selected services and controls. The essence of the present invention is that by monitoring the traffic between the SSS and the end-user, the network device detects the packets containing the user selected services and controls. These packets, after having been identified by the SSS, may be marked, for example, by their TCP port number, by the type of TCP packet, by an HTTP error status, and/or by a special token within the HTTP part of the packet. The token is meaningful only to the SCS, and does not influence the end-user WEB browser. In this way, a typical SCS can receive the TCP requests from the SSS, and subsequently identify and implement the embedded commands.

The network device may, for example, be a Service Creation System of an ISP, implementing services provided by the ISP to Internet end-users. The end-user traffic must pass through the network device in two directions, from the user towards the Internet and also from the Internet towards the end-user. There are many possibilities to implement such a constraint, such as using a Point-to-Point protocol, or using a tunnel. Some of the possible tunnels are L2TP, ATM virtual circuits or FR virtual circuits, MPLS tunnels, PPPoE, IP in IP, GRE, and others. The user can also connect to an Access Server and then be tunneled to the network device. Another possibility is for an Access Router to direct traffic directly to the network device using Policy Based Routing.

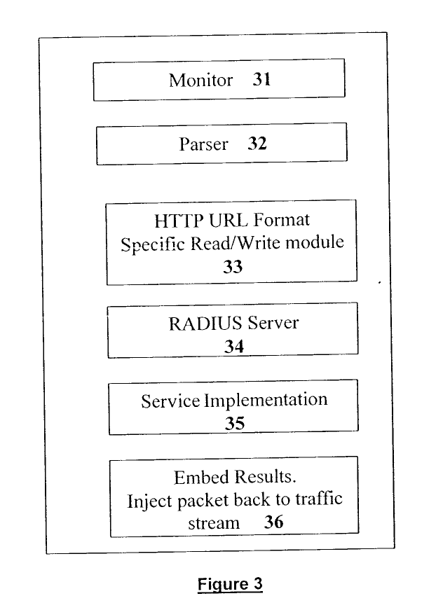

As can be seen in FIG. 3, the network device includes the following functional modules:

i. A Monitor component 31, for tracking HTTP requests from the server to the client, for determining whether the requests are sent from a specific, pre-defined port, and in order to identify message status codes, such as redirect status codes or GET codes.

ii. A Parser component 32, for analyzing the HTTP URL fields of requests sent from the elected port, to determine whether the requests are HTTP redirect requests, and if so, to verify whether the content of the HTTP URL fields is in accordance to the pre-determined format (provided to the SSS and SCS prior to operation). The parser enables determining of the service commands embedded within the HTTP URL fields, such that received commands are implemented in the SCS.

iii. A module 33 for reading of users' service requests and for writing information in query fields of the HTTP redirect URL query according to a pre-determined format.

iv. Optionally, the SCS can connect to a RADIUS server 34 to provide authentication (for authenticating the user identity), authorization (for verifying request allowability) and accounting services (for calculating usage statistics to be used for billing) to the SCS.

v. The SCS enables immediate implementation of services, once authorized, by an implementation module.

vi. The results of these services may optionally be embedded in the HTTP URL fields by the SCS 36

The Methodology of the Present Invention

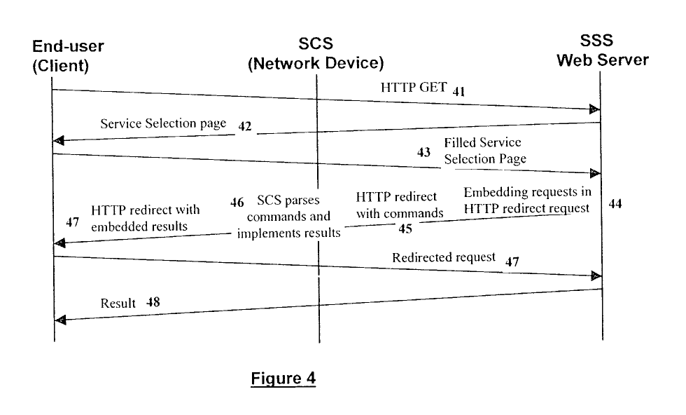

According to a preferred embodiment of the present invention, the method of implementing the service requests is as follows, as can be seen in FIG. 4:

a. Providing the SSS and SCS with a simple code that enables reading/writing of a specific HTTP URL query field format. This format encompasses the embedded service commands and optionally additional service related information.

b. Determining that content sent from the Web server for the purposes of requesting service commands is assigned to a specific port number. In this way, all command requests from clients to the Web server are configured to be responded to from a specific (not commonly used) port that is later used to identify such commands by the network device;

c. Requesting a service selection page from a server, by a client, by sending the server an HTTP GET command 41;

d. Sending a service selection page to a client 42, from the SSS;

e. Sending a client response 43 (filled service selection page), to the Web server;

f. Identifying the service requests from the client, and converting the requests to service commands. Thereafter embedding the commands 44 in standard HTTP URL fields (the URL query fields), according to a particular format, within an HTTP redirect request;

g. Sending the HTTP request 45 (with the embedded commands) to the client. The HTTP request is sent from a pre-determined port (that can be identified by the SCS), and the request is an HTTP redirect request type.

h. Intercepting the HTTP request 46 by a network device (SCS) and identifying the request port number, such that only those requests sent from the specified port (as described above) are further selected for parsing;

i. Determining that the HTTP requests received from the determined port is an HTTP redirect request, by the network device 46;

j. In the case where the request is sent from the particular port and is an HTTP redirect request, parsing the request 46 in order to identify whether the request has embedded commands that are embedded in the HTTP URL fields according to the pre-determined URL query format;

k. Reconfiguring the user's service profile, based on the embedded service commands, and implementing 46 the embedded service commands in the network device;

l. The request then continues to the client, but since it is an HTTP redirect request, it is automatically redirected 47 to the SSS;

m. The SSS may optionally send an HTTP message to the client, containing the service request results and the query results. The redirecting is necessary for the provision of query results and for the WEB server to know that the service request was executed. At this stage, the requested service has already been implemented in the SCS, and is utilized by the end-user. The SSS may accordingly present a WEB page to the user indicating success or failure of the service request. It may also provide the user with the results of the query requests.

The Embedded Commands:

The specific format for the content of the HTTP URL query field is, by way of example, as follows:

http://hostname.com/?START?Service=ServiceName&RESULT=--?CLI=099601520&RESULT=--?END

As can be seen above, there are several parts of the URL query field that can be modified for the purpose of embedding the service commands, according to the present invention. The HTTP URL query field can include the relevant service commands (Service=), and the Enhanced Dynamic Service (EDS) query field can include client enquiries, such as Calling Line Identification (CLI). The EDS query field is a special field within the HTTP redirect URL query. Typical HTTP URL fields are characterized by a host address, such as HTTP://www.yahoo.com/ and a query field, identified according to one or more question marks in the URL. The service type and service enquiry commands, according to the present invention, are placed in the area of the question marks (after the host name filed), in a format that can be understood by both the Web server and the network device.

For each of the fields there is typically a RESULT field, which enables the network device to optionally add the result of the service request (such as failure, success etc.).

According to an additional embodiment of the present invention, the network device examines the services and controls requested by the end-user and may connect to a RADIUS server to authorize, authenticate and/or provide accounting services to the network device, in relation to the user who requested the service. The RADIUS server and the associated functions performed by it are known in the art. Once such authorization is granted, the services and actions required are immediately implemented by the network device. In this case, the network device inserts RESULTS data required by the SSS into the HTTP URL fields. The information for EDS queries can come from the network device itself or from the RADIUS server. This information may also be used by the SSS to provide the end-user with feedback as to the success/failure of the required service implementation or provide the end-user with query results. The network device may also be required to perform other operations on the packet, such as recalculating differences in the TCP checksum, and inserting the packet back into the traffic stream. The packet subsequently continues towards its original destination (such as the end-user WEB browser).

According to the present invention, packets containing the embedded commands are typically HTTP redirect packets with a redirect status code. These commands cause the end-user browser to redirect the packet back to the SSS. The redirected packet arrives at the SSS containing the embedded results and information inserted by the network device. If the invention is used by an ISP to provide services for Internet users, the SSS may then issue a WEB page to the end-user containing, among other things, feedback on the success/failure of the service request.

Advantages

The present invention has many advantages over current methods and systems for implementing end-user control and self-subscribed services. It is very efficient since there is no HTTP server or proxy server within the network device. Furthermore, parsing is only required for a very limited number of packets that pass through the network device (only those that were noticed by the monitor as having been sent from a particular port). In addition, the present invention enables the user to be redirected to the WEB server automatically, without a prior knowledge of the URL of the WEB server.

There is no special protocol required for the interaction and the communications between the SSS and the network device. There is no need for a manager and an agent relationship or for a client-server relationship. As a result the system can be integrated into the Service Provider network smoothly and transparently. There is no need for additional special devices or protocols such as Policy servers or service managers, and therefore the basic network functioning is maintained, without the need for reconfiguring the data flow in the ISP network.

Many network devices can be controlled by a single SSS. The SSS can therefore be centralized, while the network devices are distributed. In this way, services can be provided to users from a central location, and changes in the services and controls offered to customers or changes in the human interface of these offered services, can all be executed at a single location, on the SSS.

According to an additional embodiment of the present invention, the network device enables inserting of feedback for the SSS. Such feedback is typically composed within the RESULTS field of the URL query, the EDS query fields (like CLI and others) and/or in other fields. The feedback may include the success/failure of granting the services and controls requested and other information requested by the SSS. The feedback, for example, is embedded into the HTTP requests in the RESULTS fields, and the number of bytes in the requests is kept constant, thereby leaving TCP byte counts unaltered. Other fields in the packet are not changed and the packet is immediately inserted back into the downstream traffic flow.

According to an additional embodiment of the present invention, both the SSS and the network device can be enabled to authenticate and authorize each service request, in order to verify that the user requesting the network service is authenticated and authorized to do so. In the case of the network device, this function is enabled by the addition of an authentication/authorization module/component, such as a RADIUS server, to the network device. The SSS and the network device can authenticate each other and can also authenticate the user.

According to an additional embodiment of the present invention, the network device enables secure data transactions, in order to verify that the details of every request made by a user is processed according to acceptable security standards. The SSS and the network device can perform standard authentication procedures, since there can be a security association between them, and therefore the communication between the SSS and the network device is like any other secure communications between two devices in the network. In this case, the SSS can provide the network device with the user credentials. The SSS, for example, may send the user name and password to the network device. This information may be encrypted using the security association between the devices, in order to prevent the WEB browser from accessing this information. The security association that is established between the SSS and the network device can provide a degree of security as high as needed. An additional possibility is to enhance security by verifying that the packets arriving from the WEB browser (in the upstream direction) have not been altered by the user.

According to an additional embodiment of the present invention, a billing platform can be incorporated so as to enable individualized billing of services on a per user basis. This function is enabled by the addition of a RADIUS server that provides accounting services to the network device.

According to a further embodiment of the present invention, an additional monitoring platform can be incorporated so as to enable the network device to monitor the traffic in the upstream direction in addition to or in place of monitoring the downstream traffic. According to the monitoring functionality, the special HTTP packets containing the service requests are redirected by the WEB browser. On their return path they pass through the network device and can be monitored at that point. To enable upstream monitoring of the special HTTP packets, the HTTP packet is embodied in a GET message rather then in a redirect message. The special format is now in the GET URL field but its format is still preserved. Subsequently, the destination port (instead of the source port) should be checked for the special port number. The Monitor is the only module in the SCS that is changed relative to the downstream implementation. The other modules are unchanged and function exactly the same as in the downstream implementation.

If a secured association between the SSS and the network device is needed, the variation has a disadvantage in that the network device cannot write over information that should not reach the WEB browser. Such a consequence provides a security compromise, as the client may have access to controlling the services.

The foregoing description of the embodiments of the invention has been presented for the purposes of illustration and description. It is not intended to be exhaustive or to limit the invention to the precise form disclosed. It should be appreciated that many modifications and variations are possible in light of the above teaching. It is intended that the scope of the invention be limited not by this detailed description, but rather by the claims appended hereto.

What is claimed is:

1. A system for enabling an end-user in a data network to control network services offered by a Service Provider, comprising:
a Web server, said Web server processing end-user service requests and embedding said service requests in a URL query field of a standard HTTP message; and
a network device for implementing said end-user services, according to said service requests.

2. The system of claim 1, wherein said Web server further comprises means for sending said embedded service requests within HTTP redirect messages, said requests being sent from a specific port that identifies said messages as potential service request messages.

3. The system of claim 1, wherein said Web server further comprises means for embedding said service requests in accordance with a determined format in an EDS field.

4. The system of claim 1, wherein said network device further comprises means for identifying said embedded service requests.

5. The system of claim 1, wherein said network device further comprises means for embedding service command results according to a determined format.

6. The system of claim 1, wherein said network device further comprises:
a Monitoring component, for tracking HTTP requests to determine origin port numbers of requests received from said Web server, and for identifying message status codes;
a Parser component, for analyzing content of said service commands received from a specified port number; and
a Service implementation component, for implementing said service.

7. The system of claim 6, further comprising a Results Implementation component, for embedding results of said service commands in standard HTTP protocol URL fields, according to a determined format.

8. The system of claim 6, further comprising a RADIUS server component, for providing services to said network device, said services selected from the group consisting of authentication, authorization and accounting services.

9. The system of claim 6, further comprising a security module for enabling secure communications of data between said Web server and said network device.

10. The system of claim 6, further comprising an additional monitoring platform, for enabling said network device to monitor traffic in an upstream direction.

11. The system of claim 1, wherein said Web server controls a plurality of said network devices.

12. A method for enabling an end-user in a data network to control network services offered by a Service Provider, comprising:
i) providing a means for reading and writing specific command formats within a URL field of a standard WEB page, to a Web server and to a network device;
ii) receiving an elected service request, by said Web server, and embedding said service request as a service command in a standard HTTP redirect request for the end-user, said service command complying with said specific format of URL fields of a standard HTTP message;
iii) intercepting said HTTP request by a network device, and monitoring said request for a request port number and for request type;
iv) if request received is from a determined port number, and is an HTTP redirect request, parsing said request to identify format of content contained within said URL field of a standard HTTP message; and
v) for commands that are compliant with said specific format of URL fields of said standard HTTP message, extracting said commands and implementing said commands in said network device.

13. The method of claim 12, further comprising:
vi) redirecting said HTTP request with said service command to said Web server, and
vii) providing said requested network service to the user, by said Web server.

14. The method of claim 12, wherein before the step of implementing said commands in said network device, connecting said network device to a RADIUS server to enable additional services for said network device, said services selected from the group consisting of authentication, authorization and accounting services.

15. The method of claim 14, further comprising embedding results of said additional services into said specific HTTP URL field format.

16. The method of claim 12, further comprising the step of providing an additional monitoring platform, for enabling said network device to monitor said HTTP requests in an upstream direction, according to the steps of:
a. embodying said HTTP packet in a GET message; and
b. checking a destination port of said HTTP packet, for a special port number.

17. A method for communicating controls from a WEB server to a network device, comprising:
i) commanding the Web server to provide a particular port number to all service requests served in a network, and providing a means of reading and writing said service requests according to a determined HTTP URL field format;
ii) providing the network device With means to read and sprite said service requests according to a specific HTTP URL field format;
iii) receiving a service request from a client, to the Web server;
iv) extracting said service request, and embedding said service request as a service command in a standard HTTP redirect message, according to said determined HTTP URL field format, said HTTP request being from a determined port;
v) sending said HTTP message to said client;
vi) intercepting said HTTP message by the network device, according to said determined port; and
vii) if said commands in said HTTP message comply with said specific HTTP URL field format, implementing said service commands.

18. The method of claim 17, further comprising connecting the network device to a RADIUS server, for providing additional services to the network device, said services selected from the group consisting of authentication, authorization and accounting services.

19. The method of claim 18, further comprising the step of embedding results of said additional services in said HTTP redirect message according to a specific HTTP URL field format.

20. The method of claim 17, further comprising adding a security module to the network device, said security module enabling secure communication of data between the WEB server and the network device.
